(19) United States
(12) Patent Application Publication
(10) Pub. No.: US 2024/0275092 A1
(43) Pub. Date: Aug. 15, 2024

(54) CONNECTION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasunori ASANO, Mie (JP); Takumi WATANABE, Mie (JP)

(21) Appl. No.: 18/564,018

(22) PCT Filed: May 16, 2022
(86) PCT No.: PCT/JP2022/020313

§ 371 Date: Nov. 24, 2023

(30) Foreign Application Priority Data
Jun. 4, 2021 (JP) 2021-094116

(51) Int. Cl. H01R 12/73; H01R 12/91; H01R 31/06

(52) U.S. Cl. CPC H01R 12/73; H01R 12/91; H01R 31/06

(57) ABSTRACT

It is aimed to provide a connection device capable of dealing with a positional deviation between boards. A connection device is provided with a wire to be routed between two boards facing each other, a board-side first connector to be provided on the upper board, a board-side second connector to be provided on the lower board, a first connector provided on one end part of the wire, a second connector provided on the other end part of the wire, an adapter extending from the first connector toward a side where the board-side second connector is located while covering the wire, and movement allowing portions provided between the adapter and the board-side second connector and allowing the adapter to relatively move in parallel to the boards with respect to the board-side second connector.

### TECHNICAL FIELD

The present disclosure relates to a connection device.

### BACKGROUND

Patent Document 1 discloses a pair of male and female connectors connectable to each other. An outer conductor of the male connector includes a tapered portion expanded toward the female connector. An outer conductor of the female connector includes a plurality of fingers resiliently deformable radially inward. Each finger is resiliently deformable radially inward. When the both connectors are connected, each finger slides on the tapered portion and inner conductors of the both connectors reach a connectable state.

### PRIOR ART DOCUMENT

### Patent Document

Patent Document 1: U.S. Pat. No. 7,563,133

### SUMMARY OF THE INVENTION

### Problems to be Solved

In the case of Patent Document 1, if the both connectors are largely deviated in position in a lateral direction orthogonal to a connection direction, a relative positional relationship of each finger and the tapered portion also largely deviates. Thus, the inner conductors cannot reach the connectable state. As a countermeasure against this, even if the tapered portion is, for example, largely guided, there is a limit due to structural restrictions and it may not be possible to sufficiently deal with a positional deviation between the both connectors in the lateral direction. Particularly, in the case of connection between two facing boards, there is a problem that it is difficult to deal with a deviation between connection positions of the boards.

Accordingly, the present disclosure aims to provide a connection device capable of dealing with a positional deviation between boards.

### Means to Solve the Problem

The present disclosure is directed to a connection device with a wire to be routed between two boards facing each other, a board-side first connector to be provided on one of the boards, a board-side second connector to be provided on the other board, a first connector provided on one end part of the wire, the first connector being connectable to the board-side first connector, a second connector provided on the other end part of the wire, the second connector being connectable to the board-side second connector, an adapter extending from the first connector toward a side where the board-side second connector is located while covering the wire, and a movement allowing portion provided between the adapter and the board-side second connector, the movement allowing portion allowing the adapter to relatively move in parallel to the boards with respect to the board-side second connector.

### Effect of the Invention

According to the present disclosure, it is possible to provide a connection device capable of dealing with a positional deviation between boards.

### BRIEF DESCRIPTION OF THE DRAWINGS

FIG. 1 is a section of a connection device of an embodiment.

FIG. 2 is an enlarged section showing a state where a first connector and a board-side first connector are connected in an upper end part of the connection device.

FIG. 3 is an enlarged section showing a state where a second connector and a board-side second connector are connected in a lower end part of the connection device.

FIG. 4 is an enlarged section showing a state where a tube portion relatively moves within a range of a movement allowing portion in an adapter from the state shown in FIG. 3.

FIG. 5 is an exploded perspective view showing members constituting the first and second connectors and a wire.

FIG. 6 is an exploded perspective view showing members constituting the board-side first connector.

FIG. 7 is an exploded perspective view showing members constituting the board-side second connector.

FIG. 8 is a plan view of a board-side second housing.

FIG. 9 is a bottom view of the board-side second housing.

FIG. 10 is a perspective view of the adapter.

FIG. 11 is a bottom view of the adapter.

FIG. 12 is a perspective view showing a state where the adapter extends downward from the first connector and an overlapping portion is engaged with the board-side connector.

FIG. 13 is an enlarged front view showing a state where a protrusion is displaced in a lateral direction within a range of the movement allowing portion in an engaging hole.

### DETAILED DESCRIPTION TO EXECUTE THE INVENTION

### Description of Embodiments of Present Disclosure

First, embodiments of the present disclosure are listed and described.

(1) The connection device of the present disclosure is provided with a wire to be routed between two boards facing each other, a board-side first connector to be provided on one of the boards, a board-side second connector to be provided on the other board, a first connector provided on one end part of the wire, the first connector being connectable to the board-side first connector, a second connector provided on the other end part of the wire, the second connector being connectable to the board-side second connector, an adapter extending from the first connector toward a side where the board-side second connector is located while covering the wire, and a movement allowing portion provided between the adapter and the board-side second connector, the movement allowing portion allowing the adapter to relatively move in parallel to the boards with respect to the board-side second connector.

Since the adapter can relatively move in parallel to the boards with respect to the board-side second connector while being accompanied by the deformation of the wire in the connection device of the above configuration, a positional deviation between the boards can be absorbed.

(2) Preferably, the board-side first connector includes a guide portion expanded toward the adapter.

In the connection device of the above configuration, the adapter can relatively move in parallel to the boards with respect to the board-side second connector, and the first connector can reach a position where the first connector is connectable to the board-side first connector by being guided by the guide portion.

(3) The wire may be arranged in a twisted state between the first and second connectors.

In the connection device of the above configuration, since a positional deviation between the first and second connectors can be suppressed by a tensile force of the twisted wire, it is possible, for example, to easily avoid strong interference of the first connector and the board-side first connector due to the positional deviation between the boards.

(4) One of the adapter and the board-side second connector may be formed with a protrusion, the other may be formed with an engaging hole, the protrusion may be arranged in the engaging hole, the engaging hole may have a slot shape extending in a direction parallel to the boards, and the movement allowing portion may be formed between the engaging hole and the protrusion.

In the connection device of the above configuration, the adapter can smoothly relatively move in parallel to the boards with respect to the board-side second connector due to the slot shape of the engaging hole.

### Details of Embodiment of Present Disclosure

A specific example of an embodiment of the present disclosure is described below with reference to the drawings. Note that the present invention is not limited to this illustration, but is represented by claims and intended to include all changes in the scope of claims and in the meaning and scope of equivalents.

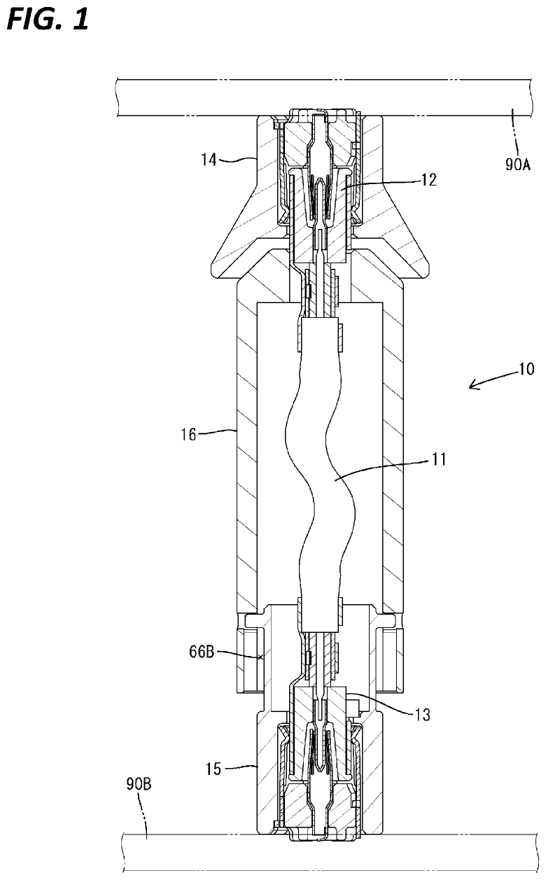

As shown in FIG. 1, a connection device 10 of this embodiment is arranged between plate surfaces of two boards 90A, 90B. The both boards 90A, 90B are printed boards and so arranged that the plate surfaces thereof are facing in parallel, and arranged apart in a vertical direction. Note that, in the following description, the board located on an upper side is referred to as a first board 90A, the board located on a lower side is referred to as a second board 90B, and the boards are merely referred to as the boards 90A, 90B when it is not necessary to distinguish the upper and lower boards. The vertical direction is not limited to a direction of gravity.

The connection device 10 is provided with a wire 11, a first connector 12, a second connector 13, a board-side first connector 14, a board-side second connector 15 and an adapter 16.

### <Wire>

The wire 11 is arranged to extend in the vertical direction between the both boards 90A and 90B. An upper end part of the wire 11 is electrically connected to the first board 90A via the first connector 12 and the board-side first connector 14. A lower end part of the wire 11 is electrically connected to the second board 90B via the second connector 13 and the board-side second connector 15.

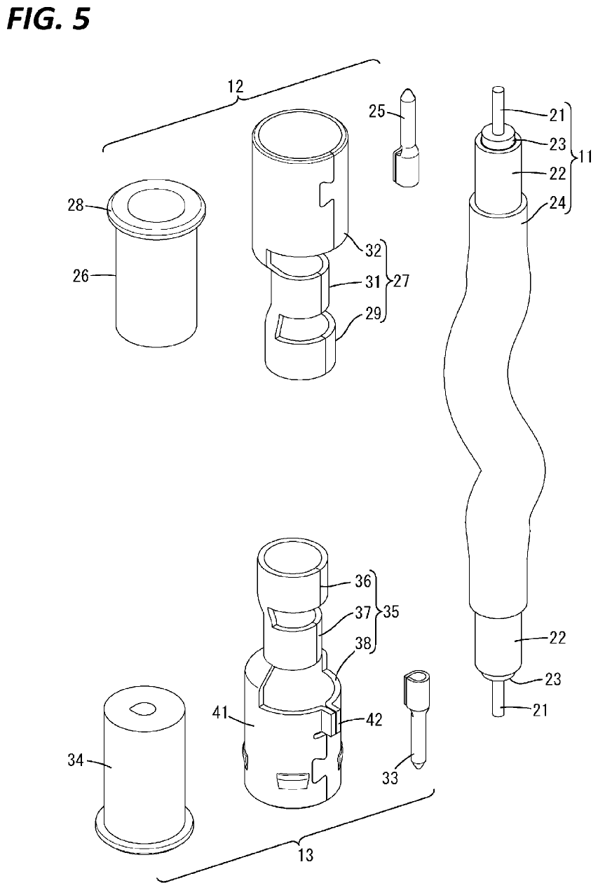

The wire 11 of this embodiment is a coaxial wire and includes, as shown in FIG. 5, an electrically conductive core wire 21, a shield portion 22 covering the core wire 21, an insulating coating 23 arranged between the core wire 21 and the shield portion 22 and an insulating sheath 24 surrounding the shield portion 22. The shield portion 22 is, for example, a braided member formed by braiding strands into a tubular shape and shields the core wire 21 from electromagnetic noise. The core wire 21, the coating 23, the shield portion 22 and the sheath 24 are exposed in the upper and lower end parts of the wire 11.

### <First Connector>

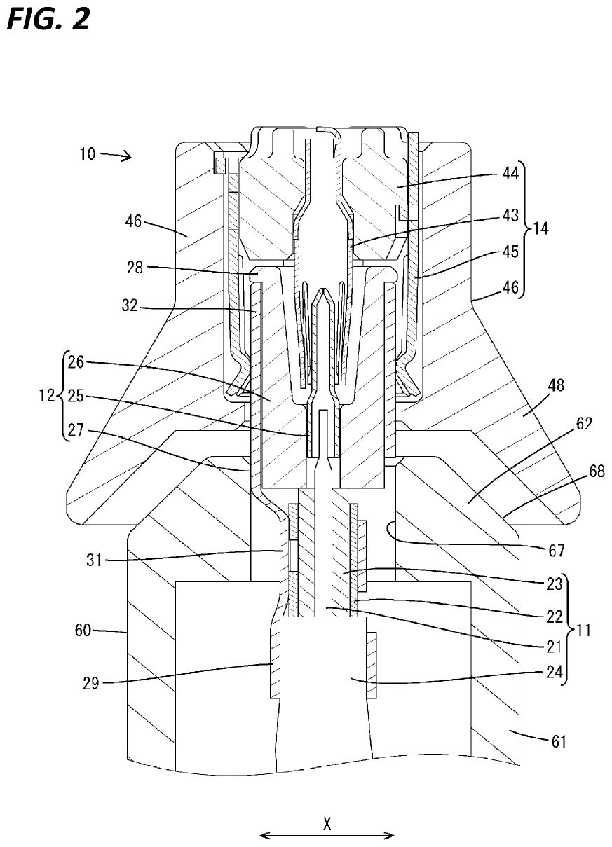

As shown in FIG. 5, the first connector 12 is provided with a first terminal 25, a first housing 26 and a first outer conductor 27. The first terminal 25 is made of electrically conductive metal, has a pin or tab shape and is connected to the core wire 21. The first housing 26 is made of synthetic resin, has a hollow cylindrical shape and is arranged between the first terminal 25 and the first outer conductor 27. The first terminal 25 is accommodated into the first housing 26. A flange portion 28 is formed to protrude over an entire circumference on an upper end part of the first housing 26. The first outer conductor 27 is made of electrically conductive metal and includes a first sheath barrel portion 29, a first shield portion barrel portion 31 located above the first sheath barrel portion 29 and a first outer conductor body portion 32 located above the first shield portion barrel portion 31. As shown in FIG. 2, the first sheath barrel portion 29 surrounds the sheath 24 and is crimped to the sheath 24. The first shield portion barrel portion 31 surrounds the shield portion 22 and is crimped to the shield portion 22. The first outer conductor body portion 32 has a hollow cylindrical shape and surrounds the first housing 26. The flange portion 28 of the first housing 26 is hooked and supported on an upper end part of the first outer conductor body portion 32.

### <Second Connector>

As shown in FIG. 5, the second connector 13 is provided with a second terminal 33, a second housing 34 and a second outer conductor 35. The second terminal 33 and the second housing 34 are respectively structured similarly to the first terminal 25 and the first housing 26 except having opposite vertical orientations. The second outer conductor 35 is made of electrically conductive metal and includes a second sheath barrel portion 36, a second shield portion barrel portion 37 and a second outer conductor body portion 38. The second sheath barrel portion 36 and the second shield portion barrel portion 37 are also respectively structured similarly to the first sheath barrel portion 29 and the first shield portion barrel portion 31 except having opposite vertical orientations.

The second outer conductor body portion 38 has a hollow cylindrical shape and includes a shell body portion 41 surrounding the second housing 34 and a stabilizer 42 projecting outward from the outer peripheral surface of the shell body portion 41. The stabilizer 42 is in the form of a double plate piece and formed by overlapping and raising parts extending from butting edge parts of the shell body portion 41.

### <Board-Side First Connector>

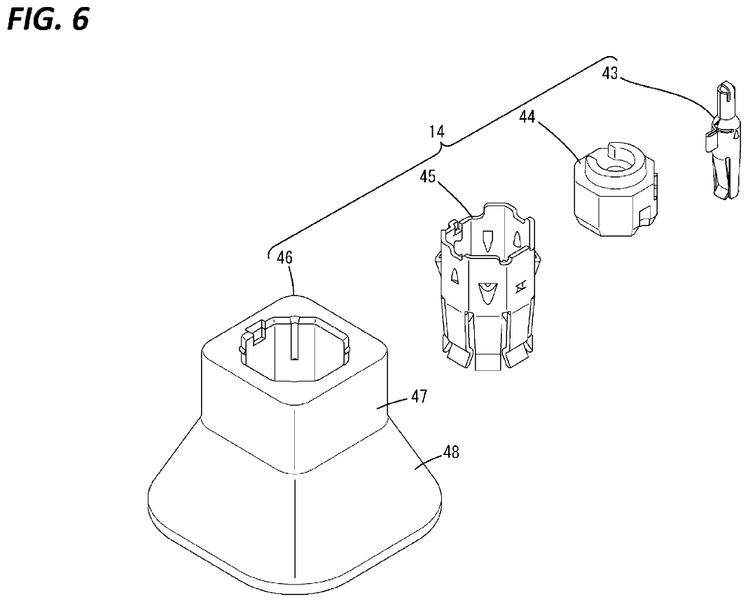

The board-side first connector 14 is provided by being mounted on the first board 90A. As shown in FIG. 6, the board-side first connector 14 includes a board-side first terminal 43, a first dielectric 44, a first shell 45 and a board-side first housing 46. The board-side first terminal 43 is made of electrically conductive metal and includes a tubular connecting part. As shown in FIG. 2, the first terminal 25 is inserted and connected from below into the connecting part of the board-side first terminal 43. Further, the board-side first terminal 43 is connected to an electrically conductive part of the first board 90A.

The first dielectric 44 is made of synthetic resin, has a tubular shape and is arranged between the board-side first terminal 43 and the first shell 45. The outer peripheral surface of the first dielectric 44 has a polygonal shape, in particular, an octagonal shape. The board-side first terminal 43 is accommodated into the first shell 45.

The first housing 45 is made of electrically conductive metal and formed into a tubular shape. The outer peripheral surface of the first shell 45 has a polygonal shape, in particular, an octagonal shape. The first shell 45 surrounds the first dielectric 44.

The board-side first housing 46 is made of synthetic resin and includes a tubular mounting portion 47 and a tapered guide portion 48 expanded downward from the mounting portion 47. The inner peripheral surface of the mounting portion 47 has a polygonal shape, in particular, an octagonal shape. The first shell 45 is mounted in the mounting portion 47 with the rotation thereof restricted. The guide portion 48 has a rectangular cross-sectional shape with rounded corners, and has a longer length in the front-rear direction than the mounting portion 47.

### <Board-Side Second Connector>

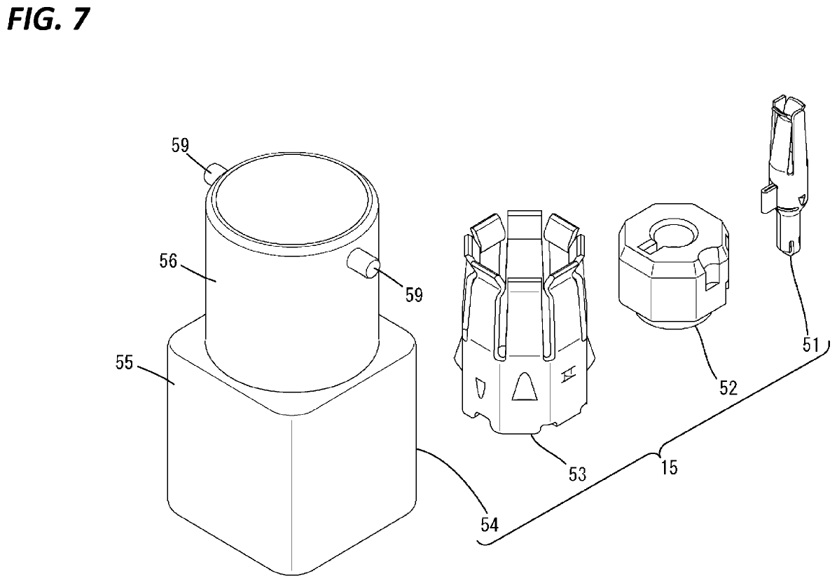

The board-side second connector 15 is provided by being mounted on the second board 90B. As shown in FIG. 7, the board-side second connector 15 includes a board-side second terminal 51, a second dielectric 52, a second shell 53 and a board-side second housing 54. The board-side second terminal 51, the second dielectric 52 and the second shell 53 are respectively structured similarly to the board-side first terminal 43, the first dielectric 44 and the first shell 45 except having opposite vertical orientations. The board-side second terminal 51 is connected to an electrically conductive part of the second board 90B.

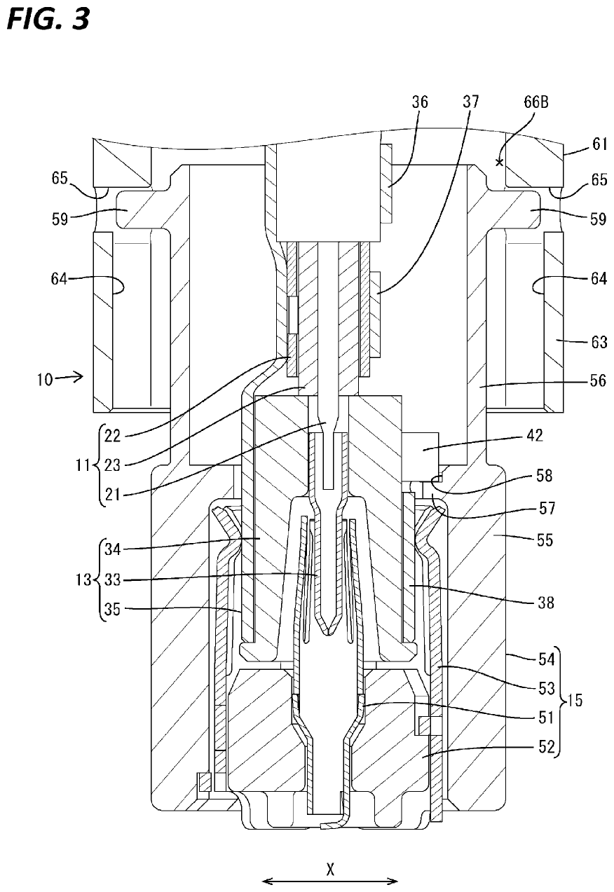

The board-side second housing 54 is made of synthetic resin and includes a base portion 55 and a tube portion 56. As shown in FIG. 9, the inner peripheral surface of the base portion 55 has an octagonal cross-sectional shape and the outer peripheral surface thereof has a rectangular cross-sectional shape. The second shell 53 is mounted into the base portion 55 with the rotation thereof restricted. As shown in FIG. 3, a step portion 57 protrudes radially inward on an upper end part of the base portion 55. The inner peripheral surface of the step portion 57 is cut to form a positioning groove 58. The positioning groove 58 is open in the upper surface of the step portion 57. The stabilizer 42 is inserted into the positioning groove 58 and positioned.

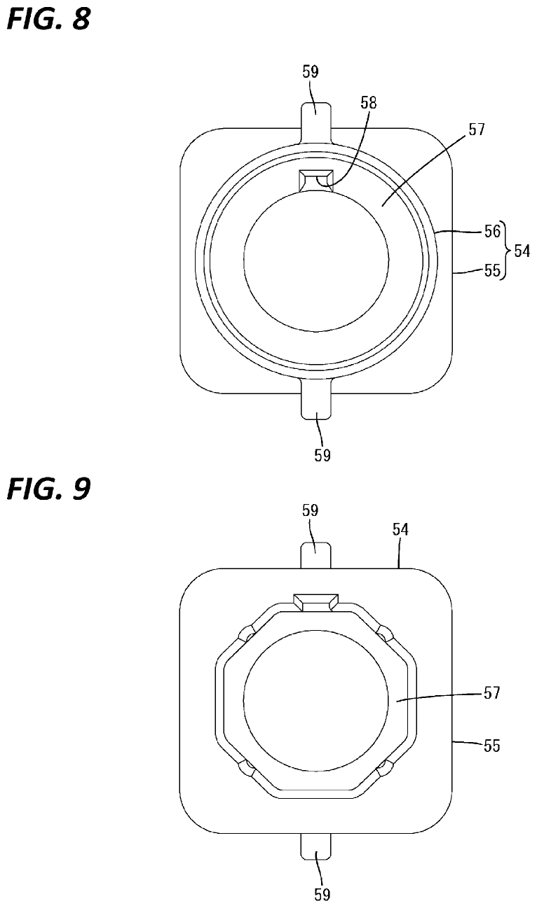

The tube portion 56 has a hollow cylindrical shape and projects upward from the upper end of the base portion 55. Both the inner and outer peripheral surfaces of the tube portion 56 have a circular cross-sectional shape, and is formed to be thinner than the base portion 55. The base end of the tube portion 56 is connected orthogonally to the step portion 57. The tube portion 56 includes a pair of cylindrical protrusions 59 projecting radially outward from the outer peripheral surface of an upper end part. As shown in FIG. 8, the both protrusions 59 are respectively arranged on opposite radial end parts on the outer peripheral surface of the tube portion 56 and project toward sides opposite to each other. One of the both protrusions 59 is arranged at a position overlapping the positioning groove 58 in a circumferential direction.

### <Adapter>

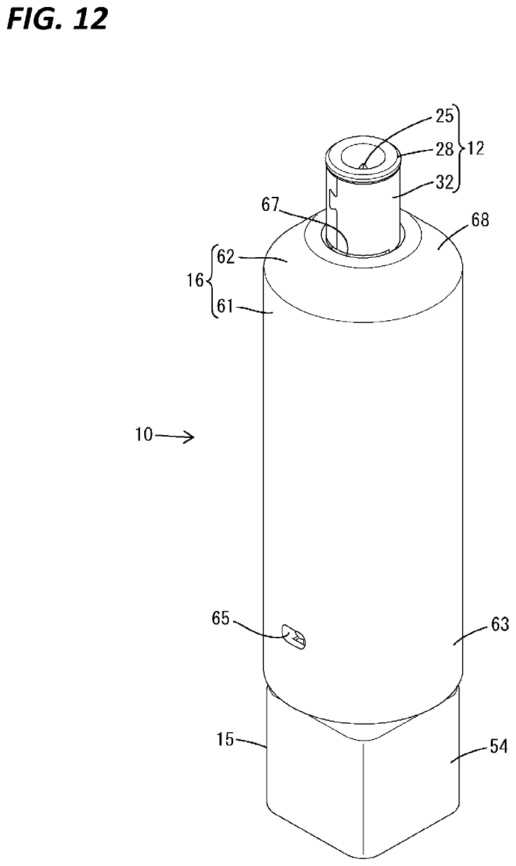

The adapter 16 is made of synthetic resin and includes, as shown in FIG. 12, a hollow cylindrical adapter body portion 61 extending in the vertical direction and an adapter tip portion 62 connected to an upper end of the adapter body portion 61 and reduced in diameter. The wire 11 is arranged in the adapter body portion 61.

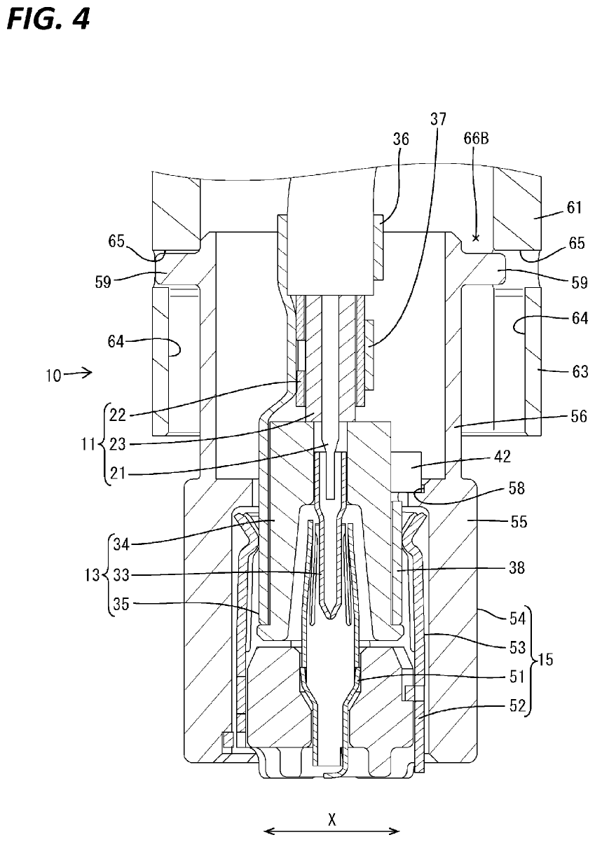

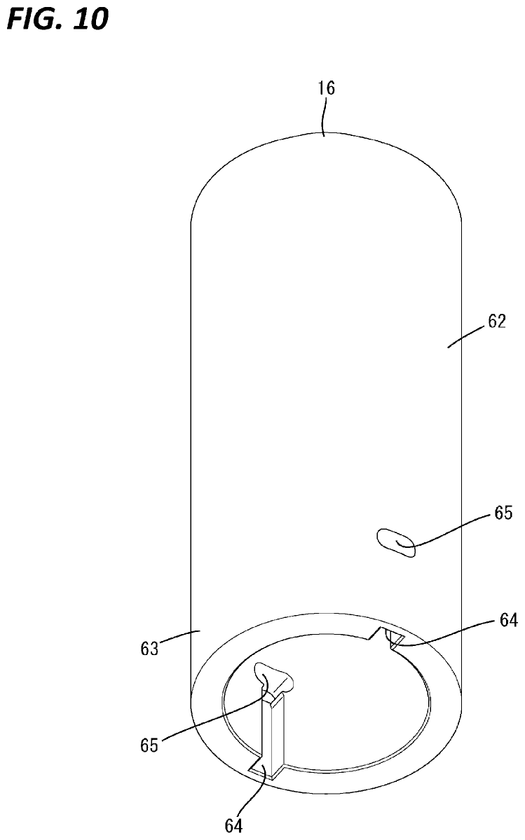

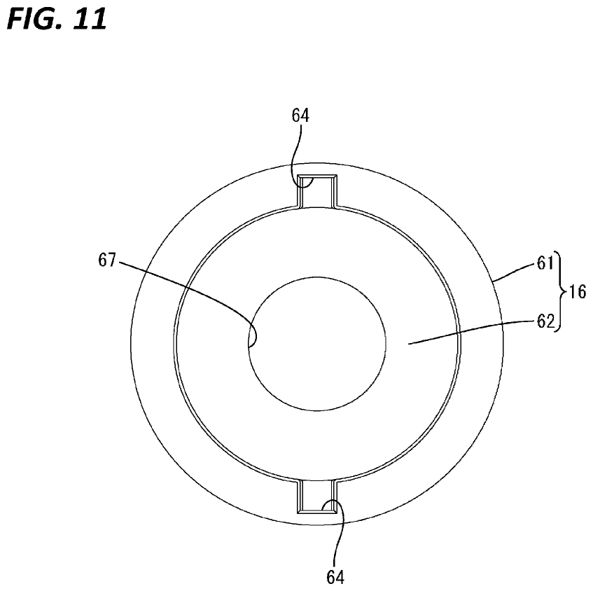

A lower end part of the adapter body portion 61 includes an overlapping portion 63 at a position overlapping the tube portion 56 in the vertical direction. As shown in FIG. 4, the tube portion 56 is arranged in the overlapping portion 63. As shown in FIGS. 4 and 10, a pair of insertion grooves 64 extending in the vertical direction and open in the lower end of the adapter body portion 61 are formed in the inner peripheral surface of the overlapping portion 63. The both insertion grooves 64 are respectively arranged on opposite radial end parts on the inner peripheral surface of the overlapping portion 63. Further, the overlapping portion 63 is formed with a pair of engaging holes 65 respectively communicating with upper end parts of the both insertion grooves 64 and radially penetrating through the overlapping portion 63. The engaging hole 65 has a slot shape extending longer in a circumferential direction of the overlapping portion 63 than in the vertical direction. The circumferential direction of the overlapping portion 63 is a direction parallel to the plate surfaces of the boards 90A, 90B and referred to as a lateral direction X below.

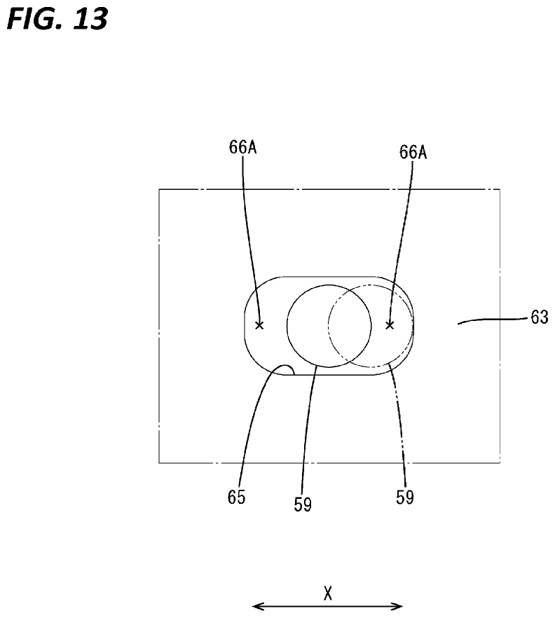

The engaging hole 65 has parts expanding toward both sides in the lateral direction X from the upper end of the insertion groove 64. The protrusions 59 are inserted into the insertion grooves 64 in the process of assembling the adapter 16 with the board-side second housing 54, and arranged in the engaging holes 65 when the assembling is completed. As shown in FIG. 13, movement allowing portions 66A for allowing a displacement of the protrusion 59 in the lateral direction X are formed between both ends in the lateral direction X of the engaging hole 65 and the protrusion 59. The protrusion 59 is displaceable also in the vertical direction in the engaging hole 65, but can be largely displaced in the lateral direction X via the movement allowing portions 66A. Further, as shown in FIGS. 3 and 4, a movement allowing portion 66B for allowing a displacement of the tube portion 56 in the lateral direction X (radial direction of the tube portion 56) is also formed between the inner peripheral surface of the overlapping portion 63 and the outer peripheral surface of the tube portion 56.

As shown in FIG. 2, the adapter tip portion 62 includes a through hole 67 penetrating in the vertical direction in a radially central part. The through hole 67 has a constant hole diameter in the vertical direction. The first outer conductor body portion 32 is arranged while being press-fit in the through hole 67.

The outer peripheral surface of the adapter tip portion 62 is formed into a tapered slope portion 68 reduced in diameter toward an upper side. The slope portion 68 has an angle of inclination corresponding to the inner peripheral surface of the guide portion 48. The upper end surface of the adapter tip portion 62 is formed to be radially flat.

### <Assembling Method and Functions and Effects of Connection Device 10>

In assembling, the first connector 12 is coupled to the upper end part of the wire 11, and the second connector 13 is coupled to the lower end part of the wire 11. Specifically, the first terminal 25 is crimped to the core wire 21 exposed in the upper end part of the wire 11, the first terminal 25 is inserted into the first housing 26 and the first sheath barrel portion 29 and the first shield portion barrel portion 31 are respectively crimped to the sheath 24 and the shield portion 22 exposed in the upper end part of the wire 11. In this way, the first connector 12 is electrically and mechanically connected to the upper end part of the wire 11. Similarly, the second terminal 33 is crimped to the core wire 21 exposed in the lower end part of the wire 11, the second terminal 33 is inserted into the second housing 34 and the second sheath barrel portion 36 and the second shield portion barrel portion 37 are respectively crimped to the sheath 24 and the shield portion 22 exposed in the lower end part of the wire 11. In this way, the second connector 13 is electrically and mechanically connected to the lower end part of the wire 11.

Subsequently, the wire 11 is inserted into the adapter 16 and the first connector 12 is press-fit into the through hole 67 and fixed to the adapter tip portion 62. As shown in FIG. 12, an upper part of the first connector 12 is arranged to project upward from the upper end surface of the adapter tip portion 62.

Further, the second connector 13 is connected to the board-side second connector 15. Specifically, the lower end part of the second connector 13 is inserted into the base portion 55 via the inside of the step portion 57, the second outer conductor body portion 38 is inserted into the second shell 53 and electrically connected, and the second terminal 33 is inserted into the connecting part of the board-side second terminal 51 and electrically connected.

When the lower end part of the second connector 13 is inserted into the base portion 55, the wire 11 is twisted more than a half turn as shown in FIG. 1 and, in that state, the stabilizer 42 is inserted into the positioning groove 58. In this way, the second connector 13 is held in the board-side second connector 15 with the rotation thereof with respect to the board-side second connector 15 restricted. The wire 11 applies a tensile force to itself by being twisted, and holds a state extending in the vertical direction in the adapter 16. Further, the protrusions 59 are inserted into the engaging holes 65 through the insertion grooves 64. Here, the adapter 16 is coupled to the board-side second connector 15 in a state relatively movable in the lateral direction X within a range specified by the movement allowing portions 66A, 66B.

Subsequently, the first board 90A is brought closer to the second board 90B and the first connector 12 is connected to the board-side first connector 14. Specifically, the first outer conductor body portion 32 is inserted into the first shell 45 and contacts the first shell 45, and the first terminal 25 is inserted into the connecting part of the board-side first terminal 43 and contacts this connecting part.

If the first connector 12 and the board-side first connector 14 are not positioned directly opposite to each other and there is a positional deviation in the lateral direction X between the boards 90A and 90B, the slope portion 68 slides on the guide portion 48, whereby the first connector 12 and the board-side first connector 14 are guided to proper connection positions directly opposite to each other. Further, the adapter 16 relatively moves in the lateral direction X with respect to the board-side second connector 15 within the range of the movement allowing portions 66A, 66B while the wire 11 is deformed, whereby the positional deviation between the boards 90A and 90B can be absorbed (floating). Specifically, as shown in FIG. 13, the protrusions 59 can move in the lateral direction X in the movement allowing portions 66A according to the positional deviation between the boards 90A and 90B while being inserted in the engaging holes 65. Further, as shown in FIGS. 3 to 4, the tube portion 56 can move in the lateral direction X in the movement allowing portion 66B while being inserted in the overlapping portion 63 according to the positional deviation between the boards 90A and 90B. Note that, also during use, the adapter 16 can similarly move in the lateral direction X with respect to the board-side second connector 15 within the range of the movement allowing portions 66A, 66B to deal with the positional deviation between the boards 90A and 90B.

As described above, since the adapter 16 can relatively move in the lateral direction X with respect to the board-side second connector 15 while being accompanied by the deformation of the wire 11 according to this embodiment, the positional deviation between the boards 90A and 90B can be absorbed. Here, since the wire 11 can be deformed, following the positional deviation between the boards 90A and 90B, and a degree of freedom in the shapes of the movement allowing portions 66A, 66B is high, a large positional deviation between the boards 90A and 90B can also be dealt with.

Further, since the board-side first connector 14 includes the guide portion 48 expanded toward the adapter 16, the first connector 12 can be guided by the guide portion 48 and reach a position where the first connector 12 is connectable to the board-side first connector 14.

Further, since the wire 11 is arranged in a twisted state between the first connector 12 and the second connector 13, a tensile force is applied to the wire 11 and a height position variation of the first connector 12 can be suppressed. As a result, strong interference of the first connector 12 and the board-side first connector 14 due to the positional deviation between the boards 90A and 90B can be easily avoided.

Furthermore, the adapter 16 is formed with the engaging holes 65, the board-side second connector 15 is formed with the protrusions 59, the engaging hole 65 has a slot shape extending in the lateral direction X, and the movement allowing portions 66A are formed between the end surfaces in the lateral direction X of the engaging hole 65 and the protrusion 59. Thus, the adapter 16 can smoothly relatively move in the lateral direction X with respect to the board-side second connector 15. Further, by the contact of the protrusions 59 with the upper and lower end surfaces of the engaging holes 65, the adapter 16 can be suppressed from relatively moving in the vertical direction with respect to the board-side second connector 15.

### Other Embodiments of Present Disclosure

The embodiment disclosed this time should be considered illustrative in all aspects, rather than restricted.

In the case of the above embodiment, the wire is a coaxial wire including the shield portion. However, as another embodiment, a wire may be a normal wire including no shield portion. If the wire includes no shield portion, the first and second connectors may not respectively include the first outer conductor and the second outer conductor and the board-side first connector and the board-side second connector may not respectively include the first shell and the second shell.

In the case of the above embodiment, the first connector and the adapter are separate from each other. However, as another embodiment, the first connector and the adapter may be integrated with each other.

In the case of the above embodiment, the protrusions are formed on the board-side second connector and the engaging holes are formed in the adapter. However, as another embodiment, the protrusions may be formed on the adapter and the engaging holes may be formed in the board-side second connector.

In the case of the above embodiment, the movement allowing portions are formed in the range where the protrusion is displaced in the engaging hole. However, as another embodiment, the adapter and the board-side second connector may not be formed with the engaging holes and protrusions and a movement allowing portion may be formed only within a displacement range of the tube portion in the adapter.

In the case of the above embodiment, the tube portion is inserted into the overlapping portion of the adapter. However, as another embodiment, the adapter may be inserted into the tube portion.

### LIST OF REFERENCE NUMERALS

10 . . . connection device
11 . . . wire
12 . . . first connector
13 . . . second connector
14 . . . board-side first connector
15 . . . board-side second connector
16 . . . adapter
21 . . . core wire
22 . . . shield portion
23 . . . coating
24 . . . sheath
25 . . . first terminal
26 . . . first housing
27 . . . first outer conductor
28 . . . flange portion
29 . . . first sheath barrel portion
31 . . . first shield portion barrel portion
32 . . . first outer conductor body portion
33 . . . second terminal
34 . . . second housing
35 . . . second outer conductor
36 . . . second sheath barrel portion
37 . . . second shield portion barrel portion
38 . . . second outer conductor body portion
41 . . . shell body portion
42 . . . stabilizer
43 . . . board-side first terminal
44 . . . first dielectric
45 . . . first shell
46 . . . board-side first housing
47 . . . mounting portion
48 . . . guide portion
51 . . . board-side second terminal
52 . . . second dielectric
53 . . . second shell
54 . . . board-side second housing
55 . . . base portion
56 . . . tube portion
57 . . . step portion
58 . . . positioning groove
59 . . . protrusion
61 . . . adapter body portion
62 . . . adapter tip portion
63 . . . overlapping portion
64 . . . insertion groove
65 . . . engaging hole
66A, 66B . . . movement allowing portion
67 . . . through hole
68 . . . slope portion
90A . . . first board (board)
90B . . . second board (board)
X . . . lateral direction (direction parallel to boards)

1. A connection device, comprising:
a wire to be routed between two boards facing each other;
a board-side first connector to be provided on one of the boards;
a board-side second connector to be provided on the other board;
a first connector provided on one end part of the wire, the first connector being connectable to the board-side first connector;
a second connector provided on the other end part of the wire, the second connector being connectable to the board-side second connector;
an adapter extending from the first connector toward a side where the board-side second connector is located while covering the wire; and
a movement allowing portion provided between the adapter and the board-side second connector, the movement allowing portion allowing the adapter to relatively move in parallel to the boards with respect to the board-side second connector.

2. The connection device of claim 1, wherein the board-side first connector includes a guide portion expanded toward the adapter.

3. The connection device of claim 1, wherein the wire is arranged in a twisted state between the first and second connectors.

4. The connection device of claim 1, wherein one of the adapter and the board-side second connector is formed with a protrusion, the other is formed with an engaging hole, the protrusion is arranged in the engaging hole, the engaging hole has a slot shape extending in a direction parallel to the boards, and the movement allowing portion is formed between the engaging hole and the protrusion.
